(19) United States
(12) Patent Application Publication
(10) Pub. No.: US 2009/0064005 A1
(43) Pub. Date: Mar. 5, 2009

(54) IN-PLACE UPLOAD AND EDITING APPLICATION FOR EDITING MEDIA ASSETS

(75) Inventors: Ryan B. Cunningham, San Francisco, CA (US); Chris Kalaboukis, Los Gatos, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/847,208

(22) Filed: Aug. 29, 2007

(51) Int. Cl. G06F 3/048

(52) U.S. Cl. 715/764

(57) ABSTRACT

System and methods for editing media assets are provided. In one example, apparatus for editing media assets includes logic (e.g., software) for causing the display of a media asset editor embedded within a web page, the editor operable to display a media asset and cause an edit of the media asset in response to user input. In one example, the media asset editor comprises a widget embedded within the web page; for example, a flash based widget. The editor may be further operable to upload media assets to remote storage, e.g., local or remote media assets or user-generated media assets. An edit to the media asset may include an edit instruction associated with the displayed media asset. In one example, the edit to the media asset may include an annotation of the displayed media asset, e.g., a text, audio, or video annotations of the displayed media asset.

### RELATED APPLICATIONS

The present application is related to U.S. patent application Ser. No. 11/786,016, titled “USER INTERFACE FOR EDITING MEDIA ASSETS,” and filed on Apr. 9, 2007, which is hereby incorporated by reference herein in its entirety. The present application is further related to U.S. application Ser. Nos. 11/622,920, 11/622,938, 11/622,948, 11/622,957, 11/622,962, and 11/622,968, all of which were filed on Jan. 12, 2007, and all of which are hereby incorporated by reference herein in their entirety.

### BACKGROUND

1. Field

The present invention relates generally to systems and methods for the editing and generation of media assets such as video and/or audio assets via a network, such as the Internet or an intranet, and in particular, to an embedded or in place upload and edit application for editing media assets.

2. Description of Related Art

Currently there exist many different types of media assets in the form of digital files that are transmitted via the Internet. Digital files may contain data representing one or more types of content, including but not limited to, audio, images, and videos. For example, media assets include file formats such as MPEG-1 Audio Layer 3 (“MP3”) for audio, Joint Photographic Experts Group (“JPEG”) for images, Motion Picture Experts Group (“MPEG-2” and “MPEG-4”) for video, Adobe Flash for animations, and executable files.

Such media assets are currently created and edited using applications executing locally on a dedicated computer. For example, in the case of digital video, popular applications for creating and editing media assets include Apple's iMovie and FinalCut Pro and Microsoft's MovieMaker. After creation and editing a media asset, one or more files may be transmitted to a computer (e.g., a server) located on a distributed network such as the Internet. The server may host the files for viewing by different users. Examples of companies operating such servers are YouTube (http://youtube.com) and Google Video (http://video.google.com).

Generally, users create and/or edit media assets on client computers before transmitting the media assets to a server. Many users are therefore unable able to edit media assets from another client where, for example, the user's client computer does not contain the appropriate application or media asset for editing. Moreover, editing applications are typically designed for professional or high-end consumer markets. Such applications do not address the needs of average consumers who lack dedicated computers with considerable processing power and/or storage capacity, and further, are not easily provided by a website owner for use by users.

### SUMMARY

According to one aspect and one example of the present invention systems and methods for an embedded media asset editing application are provided. In one example, a media asset editor is embedded in-place with a web page and may include, e.g., a flash type application, thereby allowing a user to edit and annotate media assets such as videos through the web page. Embedding the editor application within a web page, similar to typical video players, e.g., using embed and object tags, flash based, and the like, may allow a user to edit or annotate a media asset (e.g., a video) without having local software or leaving the site (e.g., without downloading an application or leaving the website to access a separate remote editor website or editor application).

In one example, apparatus for editing media assets includes logic (e.g., software) for causing the display of a media asset editor embedded within a web page, the editor operable to display a media asset and cause an edit of the media asset in response to user input. In one example, the media asset editor comprises a widget embedded within the web page; for example, a flash based widget. The editor may be further operable to upload media assets to remote storage, e.g., local or remote media assets or user-generated media assets. An edit to the media asset may include an edit instruction associated with the displayed media asset. In one example, the edit to the media asset may include an annotation of the displayed media asset, e.g., a text, audio, or video annotations of the displayed media asset.

According to another aspect of the present invention, an interface for editing media assets is provided. In one example, the interface includes a media asset editor application embedded within a web page, the media asset editor operable to display a media asset, and cause an edit of the media asset in response to user input. The interface may be displayed within a conventional browser page displayed on computing device, e.g., a client device. The interface may be operable to communicate edits to a remote server and cause an upload of a media asset to a remote storage. In one example, the interface may be operable only to upload a media asset.

According to another aspect of the present invention, a method for editing media assets is provided. In one example, the method includes causing the display of a media asset editor embedded within a web page, causing the display of a media asset within the media asset editor, wherein the media asset editor is operable to edit the media asset in response to user input. The method may further include embedding code with the web page for displaying the media asset, and in one example, the embedded media asset editor includes a widget. The method may further include receiving edits and media assets from a user device, as well as causing the communication of edits to a remote server and causing an upload of a media asset to a remote storage.

According to another aspect of the present invention, a computer-readable medium comprising instructions for editing of media assets is provided. In one example the instructions are for causing the performance of the method including causing the display of a media asset editor embedded within a web page, and causing the display of a media asset within the media asset editor, wherein the media asset editor is operable to edit the media asset in response to user input. The computer-readable medium may further include instructions for receiving edits and media assets from a user or remote computing device.

The present invention and its various aspects are better understood upon consideration of the detailed description below in conjunction with the accompanying drawings and claims.

### BRIEF DESCRIPTION OF THE DRAWINGS

The following drawing figures, which form a part of this application, are illustrative of embodiments, systems, and methods described below and are not meant to limit the scope of the invention in any manner, which scope shall be based on the claims appended hereto.

FIG. 1 illustrates an exemplary system for manipulating a media asset in a networked computing environment.

FIG. 2 illustrates an exemplary system for manipulating a media asset in a networked computing environment.

FIG. 3 illustrates an exemplary environment and flow of data for editing and uploading content via an embedded editor application.

FIGS. 4A and 4B illustrate exemplary methods for displaying an embedded editor application with a web site and editing media assets based on user input.

FIGS. 5A-5C illustrate an exemplary embedded editor application in various display states.

FIG. 6 illustrates an exemplary embedded editor application user interface for viewing and editing media assets.

FIG. 7 illustrates an exemplary computing system that may be employed to implement processing functionality for various aspects of the invention.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

A variety of web-based video editing applications such as JumpCut™ (jumpcut.com) exist; however, most web-based video editing applications require a user to be located on the website of the editing application for use. For example, a user would access the particular web based video editing application via the website in order to create and edit a movie. According to one aspect and example of the present invention, an in-place or embedded media asset editor application is provided. The editor application may be embedded within a web page and provide for the uploading, transcoding, clipping, and editing of media assets within a client and server architecture.

In one example, the editor application includes a widget which may be dropped or embedded within a web site and operable to display a user interface for the media asset editor. The editor application may allow a user to upload and/or edit media assets without reloading the page, leaving the web site, or opening a new webpage (e.g., opening a new window including an editor application). Embedding the editor application within a web site enables a third party site to allow a user to upload, edit, and/or annotate media assets at the third party's site (e.g., without leaving the site or opening additional browser or application windows).

For the sake of convenience, at times, videos are used and described as examples of media assets manipulated and subject to edit instructions/specifications by the exemplary devices, interfaces, and methods; however, those skilled in the art will recognize that the various examples apply similarly or equally to other media objects, subject to appropriate modifications and use of other functions where appropriate (e.g., viewing and editing a media asset may apply to editing a video file (with or without audio), editing an audio file, such as a soundtrack, editing still images, effect, titles, and combinations thereof).

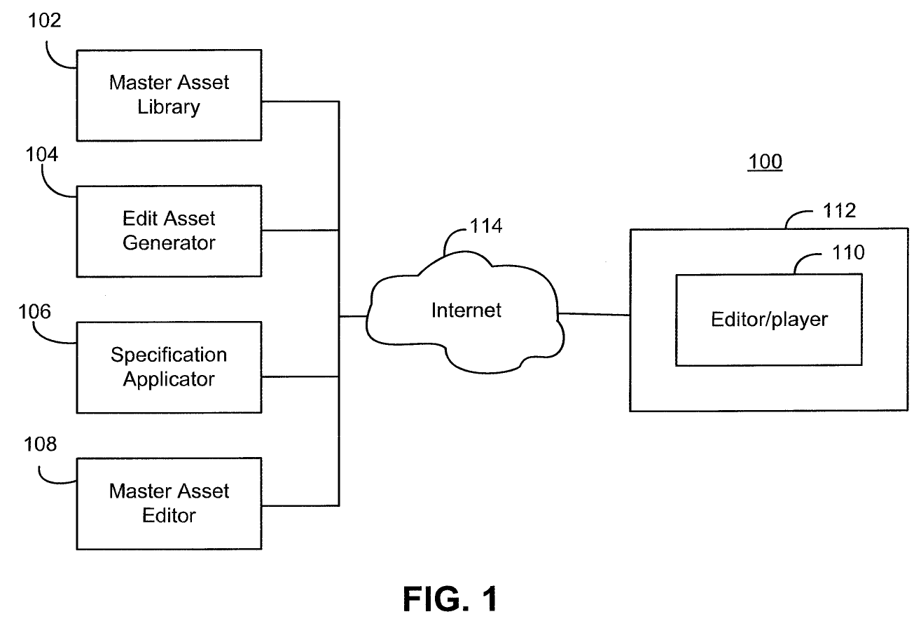

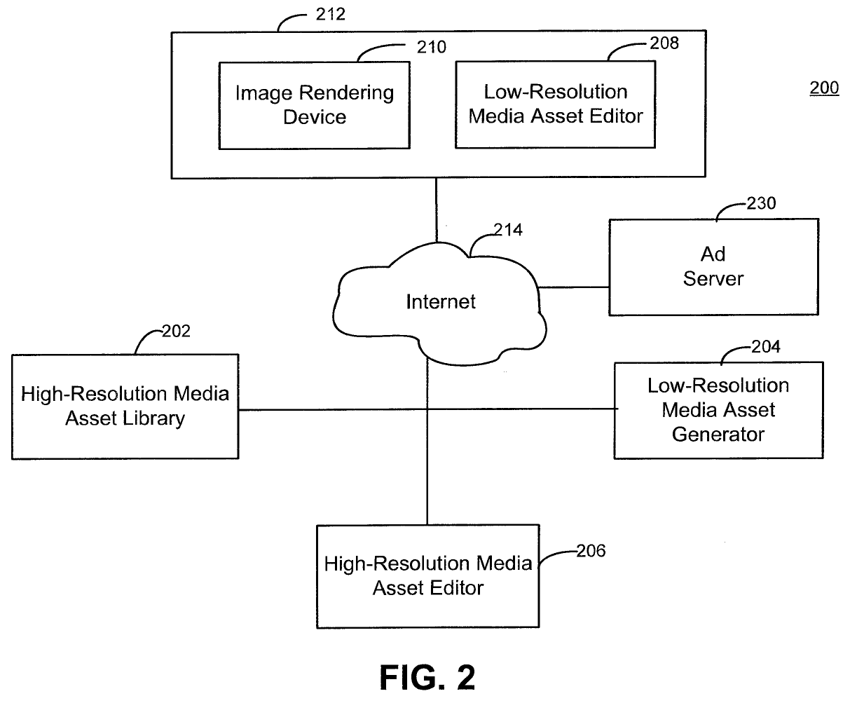

With respect initially to FIGS. 1 and 2, an exemplary architecture and process for a media asset editor application will be described (which will be followed by details of operation of the editor application embedded within a web site). The exemplary editor described herein is similar or identical to that described in co-pending U.S. patent application Ser. No. 11/786,016, titled “USER INTERFACE FOR EDITING MEDIA ASSETS,” and filed on Apr. 9, 2007, which is hereby incorporated by reference herein in its entirety. It will be understood however that other editor applications, e.g., that do not use/generate low-resolution media assets, edit specifications, and the like, are contemplated for use with a web site as described.

Specifically, FIG. 1 illustrates an embodiment of a system 100 for generating a media asset. In one embodiment, a system 100 is comprised of a master asset library 102. In one embodiment, a master asset library 102 may be a logical grouping of data, including but not limited to high-resolution and low-resolution media assets. In another embodiment, a master asset library 102 may be a physical grouping of data, including but not limited to high-resolution and low-resolution media assets. In an embodiment, a master asset library 102 may be comprised of one or more databases and reside on one or more servers. In one embodiment, master asset library 102 may be comprised of a plurality of libraries, including public, private, and shared libraries. In one embodiment, a master asset library 102 may be organized into a searchable library. In another embodiment, the one or more servers comprising master asset library 102 may include connections to one or more storage devices for storing digital files.

For purposes of this disclosure, the drawings associated with this disclosure, and the appended claims, the term “files” generally refers to a collection of information that is stored as a unit and that, among other things, may be retrieved, modified, stored, deleted or transferred. Storage devices may include, but are not limited to, volatile memory (e.g., RAM, DRAM), non-volatile memory (e.g., ROM, EPROM, flash memory), and devices such as hard disk drives and optical drives. Storage devices may store information redundantly. Storage devices may also be connected in parallel, in a series, or in some other connection configuration. As set forth in the present embodiment, one or more assets may reside within a master asset library 102.

For purposes of this disclosure, the drawings associated with this disclosure, and the appended claims, an “asset” refers to a logical collection of content that may be comprised within one or more files. For example, an asset may be comprised of a single file (e.g., an MPEG video file) that contains images (e.g., a still frame of video), audio, and video information. As another example, an asset may be comprised of a file (e.g., a JPEG image file) or a collection of files (e.g., JPEG image files) that may be used with other media assets or collectively to render an animation or video. As yet another example, an asset may also comprise an executable file (e.g., an executable vector graphics file, such as an SWF file or an FLA file). A master asset library 102 may include many types of assets, including but not limited to, video, images, animations, text, executable files, and audio. In one embodiment, master asset library 102 may include one or more high-resolution master assets. For the remainder of this disclosure, “master asset” will be disclosed as a digital file containing video content. One skilled in the art will recognize, however, that a master asset is not limited to containing video information, and as set forth previously, a master asset may contain many types of information including but not limited to images, audio, text, executable files, and/or animations.

In one embodiment, a media asset may be stored in a master asset library 102 so as to preserve the quality of the media asset. For example, in the case of a media asset comprising video information, two important aspects of video quality are spatial resolution and temporal resolution. Spatial resolution generally describes the clarity of lack of blurring in a displayed image, while temporal resolution generally describes the smoothness of motion. Motion video, like film, consists of a certain number of frames per second to represent motion in the scene. Typically, the first step in digitizing video is to partition each frame into a large number of picture elements, or pixels or pels for short. The larger the number of pixels, the higher the spatial resolution. Similarly, the more frames per second, the higher the temporal resolution.

In one embodiment, a media asset may be stored in a master asset library 102 as a master asset that is not directly manipulated. For example, a media asset may be preserved in a master asset library 102 in its original form, although it may still be used to create copies or derivative media assets (e.g., low-resolution assets). In one embodiment, a media asset may also be stored in a master asset library 102 with corresponding or associated assets. In one embodiment, a media asset stored in a master asset library 102 may be stored as multiple versions of the same media asset. For example, multiple versions of a media asset stored in master asset library 102 may include an all-keyframe version that does not take advantage of intra-frame similarities for compression purposes, and an optimized version that does take advantage of intra-frame similarities. In one embodiment, the original media asset may represent an all-keyframe version.

In another embodiment, the original media asset may originally be in the form of an optimized version or stored as an optimized version. One skilled in the art will recognize that media assets may take many forms within a master asset library 102 that are within the scope of this disclosure.

In one embodiment, a system 100 is also comprised of an edit asset generator 104. In an embodiment, an edit asset generator 104 may be comprised of transcoding hardware and/or software that, among other things, may convert a media asset from one format into another format. For example, a transcoder may be used to convert an MPEG file into a Quicktime file. As another example, a transcoder may be used to convert a JPEG file into a bitmap (e.g., *.BMP) file. As yet another example, a transcoder may standardize media asset formats into a Flash video file (*.FLV) format. In one embodiment, a transcoder may create more than one versions of an original media asset. For example, upon receiving an original media asset, a transcoder may convert the original media asset into a high-resolution version and a low-resolution version. As another example, a transcoder may convert an original media asset into one or more files. In one embodiment, a transcoder may exist on a remote computing device. In another embodiment, a transcoder may exist on one or more connected computers. In one embodiment, an edit asset generator 104 may also be comprised of hardware and/or software for transferring and/or uploading media assets to one or more computers. In another embodiment, an edit asset generator 104 may be comprised of or connected to hardware and/or software used to capture media assets from external sources such as a digital camera.

In one embodiment, an edit asset generator 104 may generate a low-resolution version of a high-resolution media asset stored in a master asset library 102. In another embodiment, an edit asset generator 104 may transmit a low-resolution version of a media asset stored in a master asset library 102, for example, by converting the media asset in real-time and transmitting the media asset as a stream to a remote computing device. In another embodiment, an edit asset generator 104 may generate a low quality version of another media asset (e.g., a master asset), such that the low quality version preserves while still providing sufficient data to enable a user to apply edits to the low quality version.

In one embodiment, a system 100 may also be comprised of a specification applicator 106. In one embodiment, a specification applicator 106 may be comprised of one or more files or edit specifications that include edit instructions for editing and modifying a media asset (e.g., a high-resolution media asset). In one embodiment, a specification applicator 106 may include one or more edit specifications that comprise modification instructions for a high-resolution media asset based upon edits made to a corresponding or associated low-resolution media asset. In one embodiment, a specification applicator 106 may store a plurality of edit specifications in one or more libraries.

In one embodiment, a system 100 is also comprised of a master asset editor 108 that may apply one or more edit specifications to a media asset. For example, a master asset editor 108 may apply an edit specification stored in a specification applicator 106 library to a first high-resolution media asset and thereby creates another high-resolution media asset, e.g., a second high-resolution media asset. In one embodiment, a master asset editor 108 may apply an edit specification to a media asset in real-time. For example, a master asset editor 108 may modify a media asset as the media asset is transmitted to another location. In another embodiment, a master asset editor 108 may apply an edit specification to a media asset in non-real-time. For example, a master asset editor 108 may apply edit specifications to a media asset as part of a scheduled process. In one embodiment, a master asset editor 108 may be used to minimize the necessity of transferring large media assets over a network. For example, by storing edits in an edit specification, a master asset editor 108 may transfer small data files across a network to effectuate manipulations made on a remote computing device to higher quality assets stored on one or more local computers (e.g., computers comprising a master asset library).

In another embodiment, a master asset editor 108 may be responsive to commands from a remote computing device (e.g., clicking a “remix” button at a remote computing device may command the master asset editor 108 to apply an edit specification to a high-resolution media asset). For example, a master asset editor 108 may dynamically and/or interactively apply an edit specification to a media asset upon a user command issuing from a remote computing device. In one embodiment, a master asset editor 108 may dynamically apply an edit specification to a high-resolution to generate an edited high-resolution media asset for playback. In another embodiment, a master asset editor 108 may apply an edit specification to a media asset on a remote computing device and one or more computers connected by a network (e.g., Internet 114). For example, bifurcating the application of an edit specification may minimize the size of the edited high-resolution asset prior to transferring it to a remote computing device for playback. In another embodiment, a master asset editor 108 may apply an edit specification on a remote computing device, for example, to take advantage of vector-based processing that may be executed efficiently on a remote computing device at playtime.

In one embodiment, a system 100 is also comprised of an editor 110 that may reside or be accessed by a remote computing device 112 that is connected to one or more networked computers, such as the Internet 114. In one example, editor 110 is comprised of one or more instructions that may be executed through another program such as an Internet browser (e.g., Microsoft Internet Explorer). For instance, editor 110 may be accessed by remote computing device 112 via a web site accessed through an Internet browser application window, where editor 110 is embedded in-place with the web site as described.

In one embodiment, an editor 110 may contain connections to a master asset library 102, an edit asset library 104, a specification applicator 106 and/or a master asset editor 108. In one embodiment, an editor 110 may include pre-constructed or “default” edit specifications that may be applied by a remote computing device to a media asset. In one embodiment, an editor 110 may include a player program for displaying media assets and/or applying one or more instructions from an edit specification upon playback of a media asset. In another embodiment, an editor 110 may be connected to a player program (e.g., a standalone editor may be connected to a browser).

FIG. 2 illustrates an embodiment of a system 200 for generating a media asset. In one embodiment, the system 200 comprises a high-resolution media asset library 202. In one embodiment, the high-resolution media asset library 202 may be a shared library, a public library, and/or a private library. In one embodiment, the high-resolution media asset library 202 may include at least one video file. In another embodiment, the high resolution media asset library 202 may include at least one audio file. In yet another embodiment, the high-resolution media asset library 202 may include at least one reference to a media asset residing on a remote computing device 212. In one embodiment, the high-resolution media asset library 202 may reside on a plurality of computing devices.

In one embodiment, the system 200 further comprises a low-resolution media asset generator 204 that generates low-resolution media assets from high-resolution media assets contained in the high-resolution media asset library. For example, as discussed above, a low-resolution media asset generator 204 may convert a high-resolution media asset to a low-resolution media asset.

In one embodiment, the system 200 further comprises a low-resolution media asset editor 208 that transmits edits made to an associated low-resolution media asset to one or more computers via a network, such as the Internet 214. In another embodiment, the low-resolution media asset editor 208 may reside on a computing device remote from the high resolution media asset editor, for example, remote computing device 212. In another embodiment, the low-resolution media asset editor 208 may utilize a browser. For example, the low-resolution media asset editor 208 may store low-resolution media assets in the cache of a browser.

In one embodiment, the system 200 may also comprise an image rendering device 210 that displays the associated low-resolution media asset. In one embodiment, an image rendering device 210 resides on a computing device 212 remote from the high-resolution media asset editor 206. In one embodiment, an image rendering device 210 utilizes a browser.

In one embodiment, the system 200 further comprises a high-resolution media asset editor 206 that applies edits to a high-resolution media asset based on edits made to an associated low-resolution media asset.

Computing device 212 includes suitable hardware, firmware, and/or software for carrying out the described functions, such as a processor connected to an input device (e.g., a keyboard), a network interface, a memory, and a display. The memory may include logic or software operable with the device to perform some of the functions described herein. The device may be operable to include a suitable interface for editing media assets as described herein. The device may further be operable to display a web browser for displaying an interface for editing media assets as described.

Additionally, an advertisement server 230 may operate to cause the delivery of an advertisement to computing device 212. Advertisement server 230 may also associate advertisements with media assets/edit specifications transmitted to or from remote computing device 212. For example, advertisement server 230 may include logic for causing advertisements to be displayed with or associated with delivered media assets or edit specifications based on various factors such as the media assets generated, accessed, viewed, uploaded, and/or edited, as well as other user activity data associated therewith. In other examples, the advertisements may alternatively or additionally be based on activity data, context, user profile information, or the like associated with computing device 212 or a user thereof (e.g., accessed via remote computing device 212 or an associated web server). In yet other examples, the advertisements may be randomly generated or associated with computer device 212 or media assets and delivered to remote computing device 212.

It will be recognized that high-resolution media asset library 202, low-resolution media asset generator 204, high resolution media asset editor 206, and advertisement server 230 are illustrated as separate items for illustrative purposes only. In some examples, the various features may be included in whole or in part with a common server device, server system or provider network (e.g., a common backend), or the like; conversely, individually shown devices may be comprise multiple devices and be distributed over multiple locations. Further, various additional servers and devices may be included such as web servers, media servers, mail servers, mobile servers, and the like as will be understood by those of ordinary skill in the art.

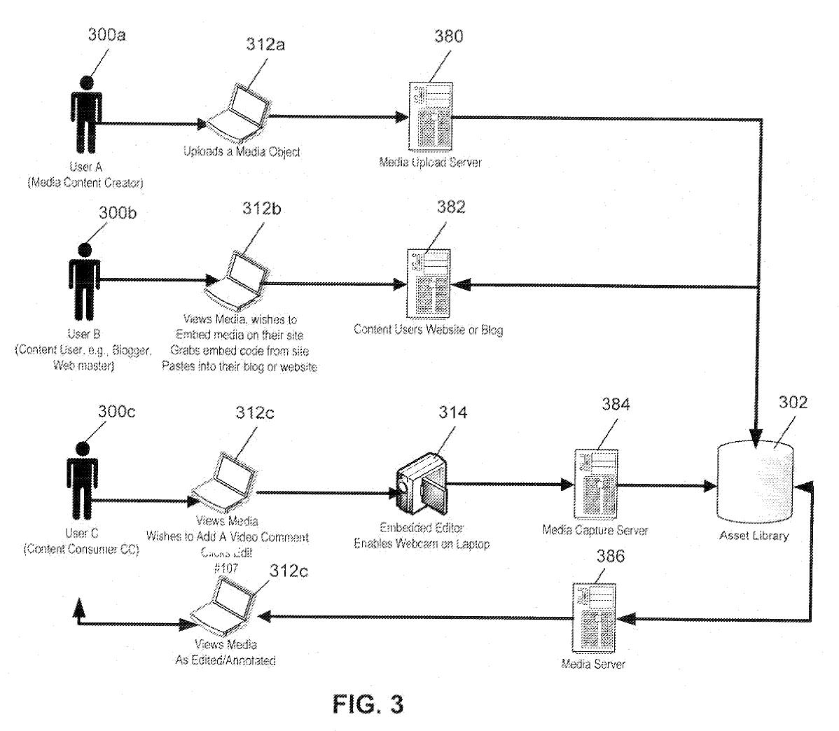

FIG. 3 illustrates an exemplary architecture and flow of data, e.g., media assets, edit specification, communications, and the like. In one example, a media asset library 302 includes media assets uploaded or generated from various users. For example, a first user 300a may upload media assets to media store 302, e.g., via a client device 312a and upload server 380.

A second user 300b may view the media assets, e.g., via client device 312b and server 382 (which may be a common or separate server from server 380). In one example, the second user 300b may include a web master, blogger, or the like, and user 300b may associate (e.g., “grab”) the embed code of the particular media asset for inclusion with a web page or blog entry. For instance, user 300b may copy the embed code (or identification) from the media gallery via client device 312b and paste the embed code into their blog or website (and saves the code on their blog host or server 382). Accordingly, when the web page or blog is accessed a player and/or editor application will be displayed including the selected media asset. In other examples, however, the web page may include a button or selection to display the media player and/or editor (e.g., via a widget or other web page feature).

In one example, the method includes generating an id and namespace to create an initial embed code. For instance, in order to create an embed code to initially drop in a web page or blog, user 300b may create an id (e.g., any unique string) within a registered namespace. In this fashion user 300b may generate video “drop spots” anywhere on their page, and the web page or blog is not required to make an API call (e.g., the id is generally sufficient to display the media player/editor). Alternatively, user 300b may go to a hosting site, e.g., Jumpcut.com, and obtain an auto-generated embed (with a unique id) that they then drop in so another user may upload and edit a media asset.

User 300c may access the blog or web page having an embedded media asset editor as selected by user 300b. Unlike typical embedded media players, the embedded media asset editor includes functionality for uploading and editing media assets directly (e.g., without leaving the web page). In one example, the web page includes an edit/annotate button, which when selected displays a set of edit functions. The set of edit functions can be determined by the content user, e.g., user 300b, and/or the content creator, e.g., user 300a. User 300c may use the features to edit the media asset, e.g., a video. Edits made to the media asset (e.g., edit specifications and/or additional media assets) may be stored with asset library 302.

In one example, an edit function includes an annotate function whereby a user may annotate the media asset with interweaved media assets. For example, as illustrated in FIG. 3, user device 312c may have an associated media asset capture device 314 such as a web camera or microphone. User 300c may annotate a media asset with comments or responses via the web camera and upload the response to media asset library 302 via media capture server 384. Once the response is captured via this method, the media asset may be replayed back to user 300c via client device 312c (at which time user 300c may continue to edit or annotate the media object).

In one example, the set of editable functions may be augmented on the fly, e.g., by user 300a, 300b, or 300c via the use of downloadable modules that can be plugged in as desired. For example, user 300a (e.g., the content creator) may wish to allow the insertion of text comments into the video (alone or in addition to annotating with audio/video). A button or selection feature on the player can be configured to load a text insertion module as needed by the in-place editor. Of course, various other editing feature relating to video editing software can also be plugged in on the fly in a similar fashion.

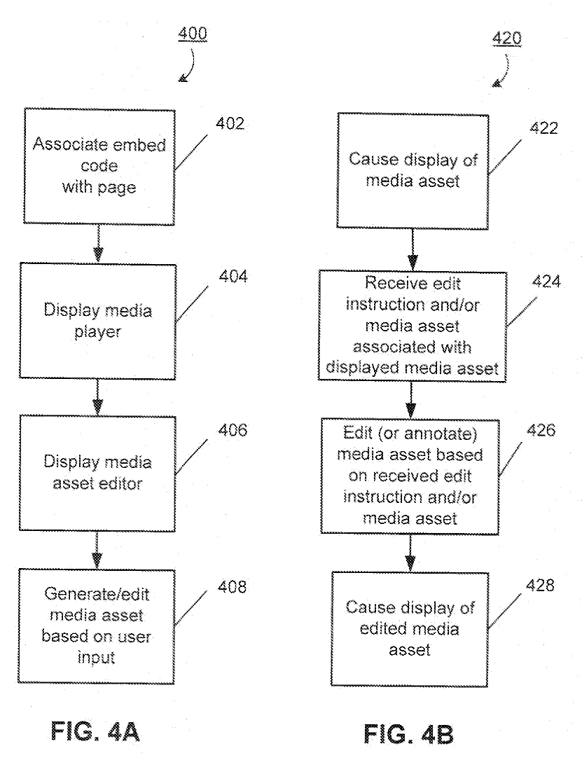

FIG. 4A illustrates an exemplary method 400 for associating a media object with an embedded editor application on a website. The method includes causing a code or identification associated with at least one media object to be included with a web page in block 402. Further, when the web page is accessed by a user (e.g., via a web browser application), the method further causes the display of a media player in block 404. The media player is displayed with one or more media assets according to the embedded code.

In response to a user selection, e.g., to edit or annotate the media object, the method further includes causing the display of an editor application or editing functions with the media player at 406. In one example, the editor or editing functions are displayed in response to selecting an edit or annotate button (or widget) displayed within the web page. In other examples, the web page may initially display a media asset editor, e.g., the initially displayed media player in block 404 may include edit functionality.

The method further includes uploading and editing (or annotating) the media assets according to the input by a user at 408. For instance, as the user makes edits or annotates media assets, the edits or annotations are uploaded to a media asset library and stored for editing the media assets. In one example, future views of the media asset by users will display the edited media asset.

FIG. 4B illustrates an exemplary method 420 for editing a media object with embedded editor application on a web page. In one example, the method includes causing the display of a media asset at block 422. The media asset may be displayed within a media player or a media asset editor. The display of a media asset and/or media editor application may be displayed according to embedded code included with a web page accessed by a client device.

In one example, the method further includes receiving an edit instruction and/or media asset from a client device at block 424. For instance, a user may edit the media asset and/or upload a media asset (e.g., to annotate the media asset). The method may further include editing and/or annotating the displayed media asset based upon the received edit instruction or media asset at block 426. Block 426 may further include storing received edit instruction and media asset, storing a new media asset based on the received edit instruction and media asset, editing the original media asset, or combinations thereof. The method may further include causing the display of the edited/annotated media asset at block 428.

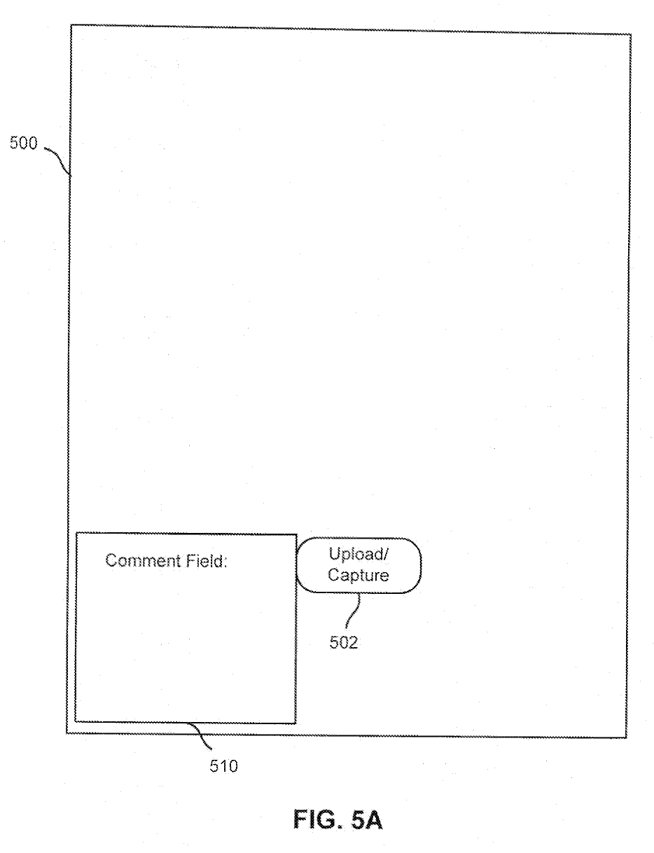

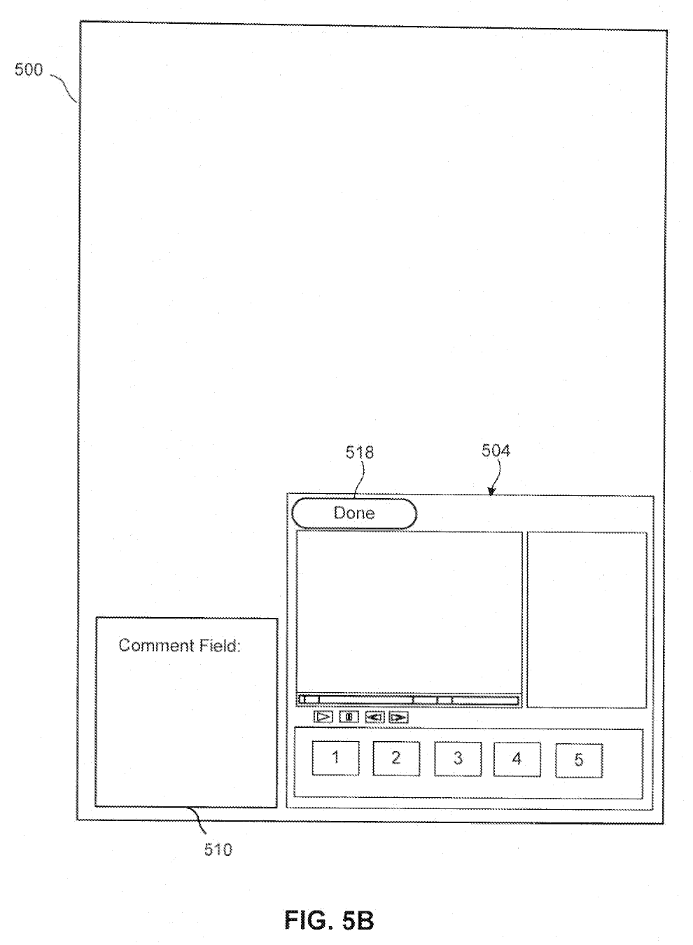

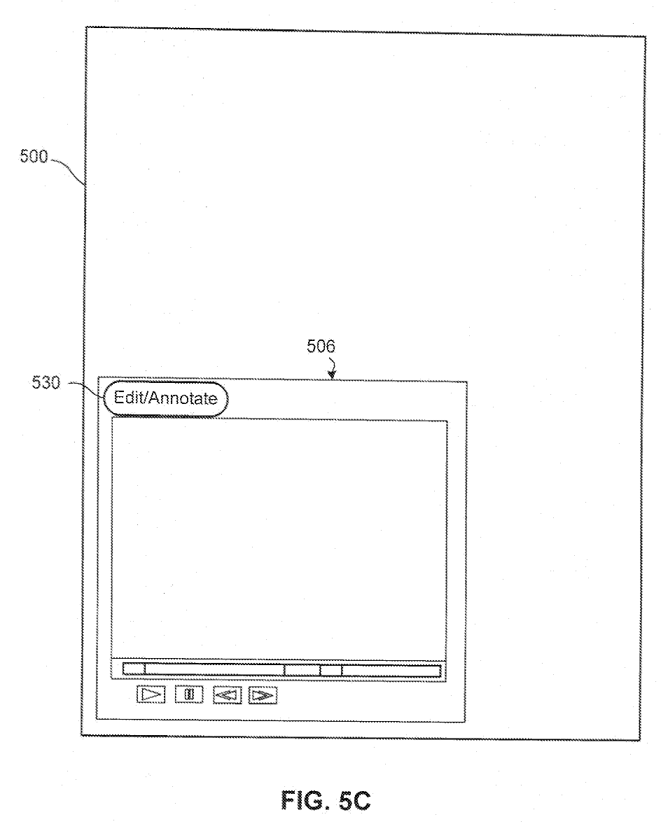

FIGS. 5A-5C illustrate an exemplary embedded editor application in various display states. In one example, the editor application is implemented via a flash based widget; however, various other methods for implementing the editor application are contemplated. For instance, an editor application may be similarly implemented via other embeddable objects or code including modules, snippets, plug-ins, embedded object tags, flash elements, java elements, html elements, or the like.

FIG. 5A illustrates an exemplary web page 500 displaying a widget 502 associated with an editor application. In this example, widget 502 is initially displayed as a button indicating to a user they may upload/capture media. For example, widget 502 may be included with or associated with a comment field 510 or other media object, and a user may select widget 502 to add a comment, e.g., via a web cam as described. In other examples, a media player may be displayed and include a widget or selection for causing the display of an editor application (or edit functions within the player as shown, e.g., in FIG. 5C described below). In yet other examples, the editor application may be display by default when web page 500 is accessed (e.g., as shown in FIG. 5B).

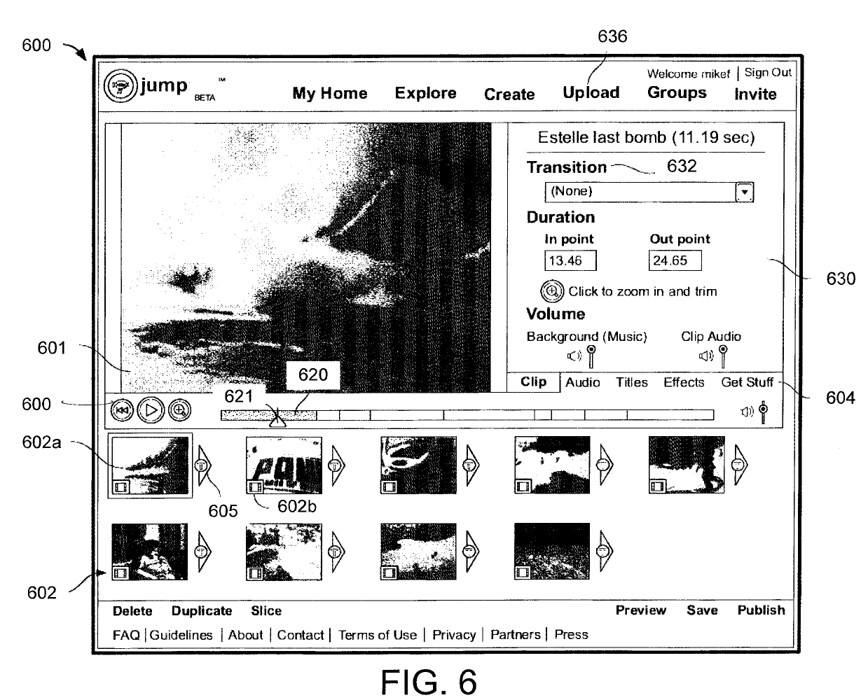

In this example, selection of widget 502 (as displayed in FIG. 5A) causes the display of widget 502 to expand and display an editor application 504 as shown in FIG. 5B (a more detailed example of an exemplary editor application interface is described with respect to FIG. 6 below). An end user may use the editor application 504 displayed via widget 502 without leaving the web page 500 or launching a new window to go to the editor application website or launch local/client-side software. When a user is finished editing the media asset(s) (which may include editing a displayed media asset and/or annotating the media asset, e.g., with comments) the user may select button 518. The editor application may then be used to view the edited media asset, revert back to the display of widget 502, or display a media player 506 as shown in FIG. 5C.

In some examples, web page 500 may initially display a media player 506 as illustrated in FIG. 5C. The web page 500 may further display a button 530 or other selector associated with media player 506 for editing or annotating media objects. For example, in response to a selection of button 530, the display of media player 506 may alter or expand to include editing functionality, e.g., similar to that shown in FIG. 5B. Additionally, after a user finishes editing or annotating media assets via an editor application, e.g., as illustrated in FIG. 5B, the display may change back to the media player 506 as illustrated in FIG. 5C.

The size of the displayed widget 502, editor application 504, and media player 506 may be varied by a user, e.g., by the content creator (e.g., user 300a) or content user (e.g., web master or blogger; user 300b), and may depend on, e.g., the particular website, the media objects to be edited, and so on. Similarly, the functions and capabilities of the editor may be varied by a user for various applications and media objects.

FIG. 6 illustrates an exemplary editor interface 600 for editing media assets, and which may be embedded within a web site and displayed, e.g., with computing device 212 illustrated in FIG. 2. Generally, interface 600 includes a display 601 for displaying media assets (e.g., displaying still images, video clips, and audio files) according to controls 610. Interface 600 further displays a plurality of tiles, e.g., 602a, 602b, etc., where each tile is associated with a media asset selected for viewing and/or editing, and which may be displayed individually or as an aggregate media asset in display 601.

In one example, interface 600 includes a timeline 620 operable to display relative times of a plurality of media assets edited into an aggregate media asset; and in one example, timeline 620 is operable to concatenate automatically in response to user edits (e.g., in response to the addition, deletion, or edit of a selected media asset). In another example, which may include or omit timeline 620, interface 600 includes a search interface for searching for media assets; for example, interface 600 may be used for editing media assets in an on-line client-server architecture as described, wherein a user may search for media assets via search interface 604 and select new media assets for editing within interface 600.

Display portion 602 displays a plurality of tiles 602a, 602b, each tile associated with a media asset, e.g., a video clip. The media asset may be displayed alone, e.g., in display 601 in response to a selection of the particular tile, or as part of an aggregate media asset based on the tiles in display portion 602. Individual tiles 602a, 602b, etc., may be deleted or moved in response to user input. For example, a user may drag-and-drop tiles to reorder them, the order dictating the order in which they are aggregated for an aggregate media asset. A user may further add tiles by selecting new media assets to edit, e.g., by opening files via conventional drop-down menus, or selecting them via a search interface displayed via 604. Additionally, each tile can be associated with a media asset or a portion of a media asset; for example, a user may “slice” a media asset to create two tiles, each corresponding to segments of the timeline, but based on the same media asset. Additionally, tiles may be duplicated within display portion 602.

In one example, each tile displays a portion of the media asset, e.g., if the tile is associated with a video clip, the tile may display a still image of the video clip. Additionally, a tile associated with a still image may illustrate a smaller version of the image, e.g., a thumbnail, or a cropped version of the still image. In other examples, a tile may include a title or text associated with the clip, e.g., for an audio file as well as a video file.

In one example, interface 600 further includes a search interface displayable in response to selection of “get stuff” 604, which allows a user to search for additional media assets. Search interface 604 may operate to search remote media assets, e.g., associated with remote storage libraries, sources accessible via the Internet, or the like, etc., as well as locally stored media assets. A user may thereby select or “grab” media assets from the search interface for editing and/or to add them to an associated local or remote storage associated with the user. Additionally, as media assets are selected a new tile may be displayed in the tile portion 602 for editing.

In one example, a search interface (e.g., displayed via “get stuff” 604) is operable to search only those media assets of an associated service provider library such as media asset library 102 or high resolution media asset library 206 as shown in FIGS. 1 and 2. In other examples, the search interface is operable to search media assets for which the user or service provider has a right or license thereto for use (including, e.g., public domain media assets). In yet other examples, the search interface is operable to search all media assets and may indicate that specific media assets are subject to restrictions on their use (e.g., only a low-resolution version is available, fees may be applicable to access or edit the high-resolution media asset, and so on).

User interface 600 further includes a timeline 620 for displaying relative times of each of the plurality of media assets as edited by a user for an aggregate media asset. Timeline 620 is segmented into sections to illustrate the relative times of each media asset as edited associated with tiles 602a, 602b for an aggregate media asset. Timeline 620 automatically adjusts in response to edits to the media assets, and in one example, timeline 620 concatenates in response to an edit or change in the media assets selected for the aggregate media asset. For example, if tile 602b were deleted, the second section of timeline 620 would be deleted with the remaining sections on either side thereof concatenating, e.g., snapping to remove gaps in the timeline and illustrate the relative times associated with the remaining media assets. Additionally, if tile 602a and 602b were switched, e.g., in response to a drag-and-drop operation, the first and second sections would switch accordingly.

In one example, as a tile is selected, e.g., tile 602a as shown, the tile is highlighted in display 602 (or otherwise displayed differently than the remaining tiles) to indicate the associated media asset being displayed in display portion 601. Additionally, the portion of timeline 620 may be highlighted as shown to indicate the portion of the media asset of the selected tile being displayed, and the relative placement of the media asset within the aggregate media asset.

User interface 600 further includes a trim feature 605 for displaying the media asset associated with one of the tiles in the display portion 601 along with a timeline associated with the selected media asset. For example, trim feature 605 may be selected and deselected to change display 601 from a display of an aggregate media asset associated with tiles 602a, 602b to a display of an individual media asset associated with a particular tile. When selected to display a media asset associated with a tile, a timeline may be displayed allowing a user to trim the media asset, e.g., select start and end edit times (the timelines may be displayed in addition to or instead of timeline 620). The selected start and end edit times generating edit instructions, which may be stored or transmitted to a remote editor.

In one example, a timeline is displayed when editing an individual media asset within user interface 600, the length of the timeline corresponding to the duration of the unedited media asset. Edit points, e.g., start and end edit points may be added along the timeline by a user for trimming the media asset. For example, a start and end time of the media asset may be shown by markers (e.g., similar to 621) displayed along the timeline, the markers initially at the beginning and end of the timeline and movable by a user to adjust or “trim,” the media asset for inclusion in the aggregate media asset. For example, a particular tile may correspond to a two-hour movie, and a user may adjust the start and end times via the timeline to trim the movie down to a five-second portion for inclusion with an aggregate media asset.

User interface 600 further includes a control portion 630 for controlling various features of a media asset displayed in display portion 601, the media asset including an aggregate media asset or individual media asset associated with a tile. In addition or instead of the above described markers along a timeline for trimming a media asset, a user may enter start and end times for a media asset via control portion 630. Further, a user may adjust the volume of the media asset being displayed and/or an audio file associated therewith. Control portion 630 further includes a transition selection 632, which may be used to select transitions (e.g., dissolve, fade, etc.) between selected media assets, e.g., between media assets associated with tiles 602a and 602b.

User interface 600 may further include an “Upload” tab 636, which switches to or launches an interface for uploading media objects to a remote storage. For example, to upload locally stored media assets to a remote media asset library, upload edit instructions, and so on as described herein.

It will be understood that user interface 600 is one specific example of an embedded interface, and other interfaces including an editor application may be used and embedded within a web page as described. For example, an embedded editor application could include functions not described here as well as fewer functions than described here.

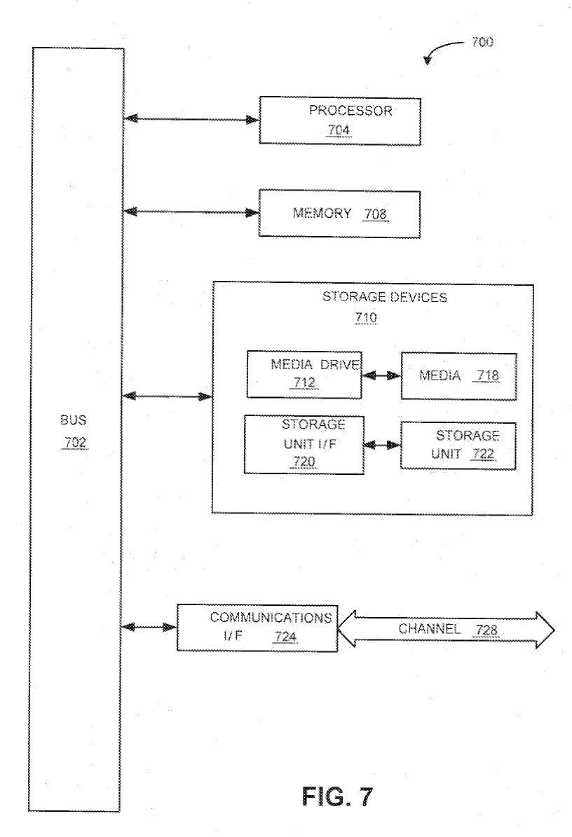

FIG. 7 illustrates an exemplary computing system 700 that may be employed to implement processing functionality for various aspects of the invention (e.g., as a client device, web server, media asset library, activity data logic/database, etc.). Those skilled in the relevant art will also recognize how to implement the invention using other computer systems or architectures. Computing system 700 may represent, for example, a user device such as a desktop, mobile phone, personal entertainment device, DVR, and so on, a mainframe, server, or any other type of special or general purpose computing device as may be desirable or appropriate for a given application or environment. Computing system 700 can include one or more processors, such as a processor 704. Processor 704 can be implemented using a general or special purpose processing engine such as, for example, a microprocessor, microcontroller or other control logic. In this example, processor 704 is connected to a bus 702 or other communication medium.

Computing system 700 can also include a main memory 708, preferably random access memory (RAM) or other dynamic memory, for storing information and instructions to be executed by processor 704. Main memory 708 also may be used for storing temporary variables or other intermediate information during execution of instructions to be executed by processor 704. Computing system 700 may likewise include a read only memory (“ROM”) or other static storage device coupled to bus 702 for storing static information and instructions for processor 704.

The computing system 700 may also include information storage mechanism 710, which may include, for example, a media drive 712 and a removable storage interface 720. The media drive 712 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 718 may include, for example, a hard disk, floppy disk, magnetic tape, optical disk, CD or DVD, or other fixed or removable medium that is read by and written to by media drive 714. As these examples illustrate, the storage media 718 may include a computer-readable storage medium having stored therein particular computer software or data.

In alternative embodiments, information storage mechanism 710 may include other similar instrumentalities for allowing computer programs or other instructions or data to be loaded into computing system 700. Such instrumentalities may include, for example, a removable storage unit 722 and an interface 720, such as a program cartridge and cartridge interface, a removable memory (for example, a flash memory or other removable memory module) and memory slot, and other removable storage units 722 and interfaces 720 that allow software and data to be transferred from the removable storage unit 718 to computing system 700.

Computing system 700 can also include a communications interface 724. Communications interface 724 can be used to allow software and data to be transferred between computing system 700 and external devices. Examples of communications interface 724 can include a modem, a network interface (such as an Ethernet or other NIC card), a communications port (such as for example, a USB port), a PCMCIA slot and card, etc. Software and data transferred via communications interface 724 are in the form of signals which can be electronic, electromagnetic, optical, or other signals capable of being received by communications interface 724. These signals are provided to communications interface 724 via a channel 728. This channel 728 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 708, storage device 718, storage unit 722, or signal(s) on channel 728. These and other forms of computer-readable media may be involved in providing one or more sequences of one or more instructions to processor 704 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into computing system 700 using, for example, removable storage drive 714, drive 712 or communications interface 724. The control logic (in this example, software instructions or computer program code), when executed by the processor 704, causes the processor 704 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

1: An interface for uploading and editing media assets, the interface comprising:
a media asset editor application embedded within a web page, the media asset editor operable to:
display a media asset; and
cause an edit of the media asset in response to user input.

2: The interface of claim 1, wherein the editor is further operable to cause an upload of a media asset.

3: The interface of claim 2, wherein the edit comprises an annotation of the media asset with a user-generated media asset.

4: The apparatus of claim 3, wherein the user-generated media asset comprises a web camera entry.

5: The interface of claim 1, wherein the edit comprises an edit instruction.

6: The interface of claim 1, wherein the editor comprises a widget embedded within the web page.

7: An interface for uploading media assets, the interface comprising:
a media asset application embedded inline within a web page, the media asset application operable to cause an upload of a media asset to a remote storage.

8: The interface of claim 7, wherein the media asset application is further operable to display the media asset.

9: The interface of claim 7, wherein the media asset application is further operable to cause an edit of the media asset in response to user input.

10: The interface of claim 9, wherein the edit comprises an annotation of the media asset with a user-generated media asset.

11-12. (canceled)

13: Apparatus for in-place editing of media assets, the apparatus comprising:
display logic for causing the display of a media asset editor embedded within a web page, the editor operable to:
display a media asset; and
cause an edit of the media asset in response to user input.

14: The apparatus of claim 13, wherein the editor is further operable to cause an upload of a media asset.

15: The apparatus of claim 13, wherein the edit comprises an annotation of the media asset with a user-generated media asset.

16: The apparatus of claim 15, wherein the user-generated media asset comprises a web camera entry.

17-19. (canceled)

20: A method for editing media assets, the method comprising:
causing the display of a media asset editor embedded within a web page;
causing the display of a media asset within the media asset editor, wherein the media asset editor is operable to edit the media asset in response to user input.

21: The method of claim 20, further comprising embedding code with the web page for displaying the media asset editor.

22: The method of claim 20, further comprising receiving a media asset from a user.

23: The method of claim 20, further comprising receiving a user-generated media asset to annotate the displayed media asset.

24: The method of claim 20, further comprising generating a second media asset based on the user input.

25: The method of claim 20, wherein the display of the media asset comprises a low-resolution media asset associated with a remotely stored high-resolution media asset.

26: The method of claim 20, wherein the editor comprises a widget embedded within the web page.

27: A computer-readable medium comprising instructions for editing of media assets, the instructions for causing the performance of the method comprising:
causing the display of a media asset editor embedded within a web page; and
causing the display of a media asset within the media asset editor, wherein the media asset editor is operable to edit the media asset in response to user input.

28: The computer-readable medium of claim 27, further comprising instructions for receiving a media asset from a user.

29: The computer-readable medium of claim 27, further comprising instructions for receiving a user-generated media asset to annotate the media asset.

30: The computer-readable medium of claim 27, further comprising instructions for generating a second media asset based on the user input.

31-32. (canceled)
